(19) United States
(12) Patent Application Publication
(10) Pub. No.: US 2015/0328657 A1
(43) Pub. Date: Nov. 19, 2015

(54) ROLLER APPLICATOR CLEANING APPARATUS

(71) Applicant: William F. Kenny, JR., Englewood, OH (US)

(72) Inventor: William F. Kenny, JR., Englewood, OH (US)

(21) Appl. No.: 14/713,665

(22) Filed: May 15, 2015

Related U.S. Application Data
(60) Provisional application No. 61/993,875, filed on May 15, 2014.

(51) Int. Cl. B05C 17/02; B44D 3/00; B08B 3/02

(52) U.S. Cl. CPC B05C 17/0245; B08B 3/02; B44D 3/006

(57) ABSTRACT

Roller applicator cleaning devices include a generally cylindrical casing having a first end having an inlet and a second end having an end face oriented transverse to a longitudinal axis thereof, and defining a chamber sized to receive a roller applicator, thereby providing generally axial fluid flow therethrough. The devices include a first end plug and a second end plug insertable into opposing ends of a roller applicator. The first end plug is integral with the first end or receivable in the first end, and the second end plug is integral with the second end or receivable in the second end of the generally cylindrical casing. The end face has a plurality of holes therethrough in fluid communication with the chamber that are concentrically arranged, and collectively define a second area. A ratio of the first area to the second area is about 2:1 to 18:1.

### TECHNICAL FIELD

The present invention relates generally to a roller applicator cleaning device, and more particularly, to a roller applicator cleaning device with generally axial fluid flow through the device to an end face transverse thereto that has a plurality of holes concentrically arranged therethrough with an area ratio of the end face to the plurality of holes (collectively) of about 2:1 to 18:1.

### BACKGROUND

This invention relates generally to devices for cleaning paint roller applicators, and, more particularly, to a device that can clean a paint roller applicator quickly and effectively by direct connection to a water supply with minimum manual labor.

The introduction of paint rollers has eased the labor required to paint walls and other surfaces, and has enabled the average individual to achieve generally excellent results. Attendant with the use of paint rollers is the question of how best to clean the roller for re-use, assuming that using a paint roller once and then disposing of it is both expensive and wasteful of resources.

A typical paint roller applicator has a cylindrical sleeve formed of generally rigid material, with a tufted or fibrous nap secured to the outer surface thereof. To apply paint to a surface, the sleeve of the paint roller applicator is generally removably secured to an inner mandrel or wire frame that is rotatably secured to a handle. After a paint roller has been used, the nap is saturated with paint, and the paint must be removed before it dries, if the roller is to be reused. It is common practice to manually remove the sleeve from the mandrel, and rinse the sleeve in solvent appropriate for the type of paint. For water-based paints, such as latex compounds, the roller sleeve may be held under the stream of water from a faucet or hose while the nap is rubbed manually to work the paint free of the fibers. This process is not environmentally friendly, and it has been very messy, time consuming, and unpleasant.

### SUMMARY

In one aspect, roller applicator cleaning devices including a generally cylindrical casing having a first end having an inlet and a second end having an end face oriented transverse to a longitudinal axis thereof, and defining a chamber sized to receive a roller applicator, thereby providing generally axial fluid flow therethrough, are disclosed. The devices include a first end plug and a second end plug insertable into opposing ends of a roller applicator. The first end plug is integral with the first end or receivable in the first end, and the second end plug is integral with the second end or receivable in the second end of the generally cylindrical casing. The end face of the second end of the generally cylindrical casing has a plurality of holes therethrough in fluid communication with the chamber. The holes collectively define a second area, and the ratio of the first area to the second area is about 2:1 to 18:1. In another embodiment, the ratio of the first area to the second area is about 3.5:1 to 18:1. In yet another embodiment, the ratio of the first area to the second area is about 8:1 to 18:1.

In any of these embodiments, the plurality of holes includes four to ten holes that each have a diameter in the range of ⅛ inch to 6/8 inch. Each hole is preferably spaced equally distant from adjacent neighboring holes and, collectively, the holes are generally concentrically arranged around a centerpoint of the end face.

In one embodiment, the plurality of holes is six to eight holes that each have a diameter in the range of 2/8 inch to 4/8 inch. Each hole is preferably spaced equally distant from adjacent neighboring holes and, collectively, the holes are generally concentrically arranged around a centerpoint of the end face.

In one embodiment, at least one of the first end or the second end of the generally cylindrical casing is a releaseably attachable cap closing an open end thereof. The generally cylindrical casing has a primary portion having a length that is about ½ inch to 2 inches shorter than the length of the roller applicator and the cap defines a remainder length necessary to encapsulate the roller applicator. In one embodiment, the primary portion is made of a transparent material.

The first end of the generally cylindrical casing may include a valve for controlling the axial fluid flow into the chamber, and the valve may include a connector connectable to a fluid source,

### BRIEF DESCRIPTION OF THE DRAWINGS

FIG. 1 is a side perspective view of one embodiment of a roller applicator cleaning apparatus.

FIG. 2 is an exploded, perspective view of the housing portion of a roller applicator cleaning apparatus.

FIG. 3 is an end view of the discharge cap of the roller applicator cleaning apparatus of FIG. 2.

FIG. 4 is a partial assembled view of the roller applicator cleaning apparatus of FIG. 1 with a roller applicator partially inserted into the tubular housing.

### DETAILED DESCRIPTION OF INVENTION

The following detailed description will illustrate the general principles of the invention, examples of which are additionally illustrated in the accompanying drawings. In the drawings, like reference numbers indicate identical or functionally similar elements.

A roller applicator cleaning apparatus is disclosed, for example a paint roller applicator, for removing paint or other coating materials from the nap or fiber of a roller applicator, and is generally referred to in the figures by reference number 100.

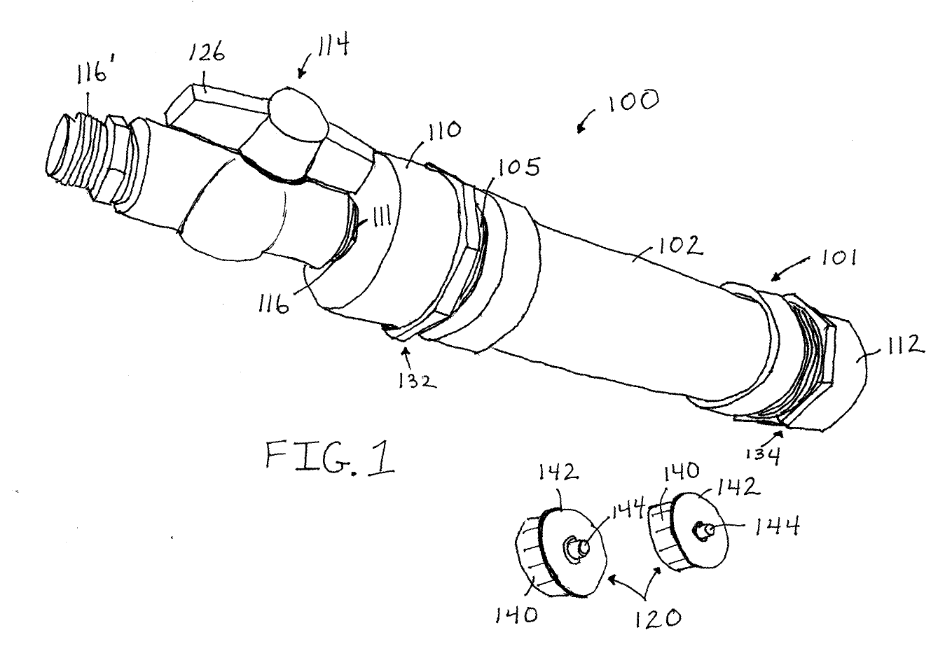

Referring now to FIGS. 1-2, the roller applicator cleaning apparatus 100 includes a generally cylindrical casing 101 having a longitudinal axis A and a tubular housing 102 defining a chamber 103 sized to receive a roller applicator. The generally cylindrical casing 101 has a first end 132 defining an opening or inlet 111 to receive fluid to cleanse the roller applicator and a second end 134 having an end face 128 (FIG. 2) defining a first area A_{EF} and being oriented transverse to the longitudinal axis A, thereby providing generally axial fluid flow from the first end 132 to the second end 134 through the chamber 103. The tubular housing 102 may have a first open end 104 and a second open end 106 as shown in FIG. 2, or one end may be an open end and the other end may be a closed end. Any open end, such as the first open end 104 and/or the second open end 106, may include threading 105, 107, respective in FIG. 2, thereby providing the ability to releasably, removably attach a cap. In FIG. 1, a fluid inlet cap 110 is threadedly connected to the first open end 104 and a discharge cap 112 is threadedly connected to the open second end 106. Accordingly, the fluid inlet cap includes a threading 113 matable to threading 105 and the discharge cap 112 includes threading (not shown) matable to threading 107, which provides a water-tight seal therebetween. While threading is shown in the figures, other connections may be possible such as a snap-fit or friction fit, or the use of latches or other connection means.

The generally cylindrical casing 101 as shown in FIG. 4 may include a transparent material for the tubular housing 102, which is typically the central, primary portion thereof. This provides the user with the advantage of being able to see the fluid introduced to cleanse the roller applicator, and to assess when the fluid has become clear, indicating that the roller applicator is clean. The tubular housing 102 is generally cylindrical and is provided with a diameter that is minimally sufficient to receive a typical paint applicator (see FIG. 4) with the nap thereof in contact with the inner surface 108 of the housing, but without compressing the nap. In one embodiment, the generally cylindrical casing 101 may have an inner diameter of about 2 inches, about 2.5 inches, about 3 inches, or about 3.5 inches, or any other diameter needed to receive a selected roller applicator therein.

The length of the tubular housing 102 portion of the generally cylindrical casing 101 may be slightly greater than the length of a roller applicator or may be smaller than the length of a roller applicator by about ½ to about 2 inches. In this second embodiment, the shorter tubular housing length 102 provides the advantage of easier removal of the roller applicator after cleansing. In particular, it provides enough surface area of the roller applicator for the user to grasp hold of to pull the roller applicator from the device. For example, if the roller applicator is nine inches in length, the tubular housing 102 may have a length of about 7 inches to about 8.5 inches. In another embodiment, if the roller applicator is 18 inches in length, the tubular housing 102 may have a length of about 16 inches to about 17.5 inches. At least one end of the generally cylindrical housing 101, for example, the discharge end cap 112 or the inlet end cap 110, is increased in length to define the remainder of the length thereof necessary to encapsulate the roller applicator therein.

Still referring to FIGS. 1-2, the first end 132, which may include the fluid inlet cap 110, includes an opening 111 therethrough fitted with a connector 116. The connector 116 forms a watertight seal with the opening 111. The connector 116 at the end opposite its connection to the opening 111 may include a fitting 118 for connection to a valve 114. The valve 114 includes a handle 126 that moves an internal structure (not shown) from an open position to a closed position (or vice versa or to a partially open position) to control the flow of fluid from a fluid source into the tubular housing 102. The valve 114 may terminate opposite connector 116 with a secondary connector 116′, which is connectable to the fluid source, such as a garden hose. In one embodiment, the connector 116 or the secondary connector 116′ may be a double hose connector or Y-shaped connector.

Referring now to FIG. 4, in an alternate embodiment, the connector 116 at the end opposite its connection to the fluid inlet cap 110 may include threading 117 for connection to a fluid source, such as a garden hose. Here, the valve 114 is not present.

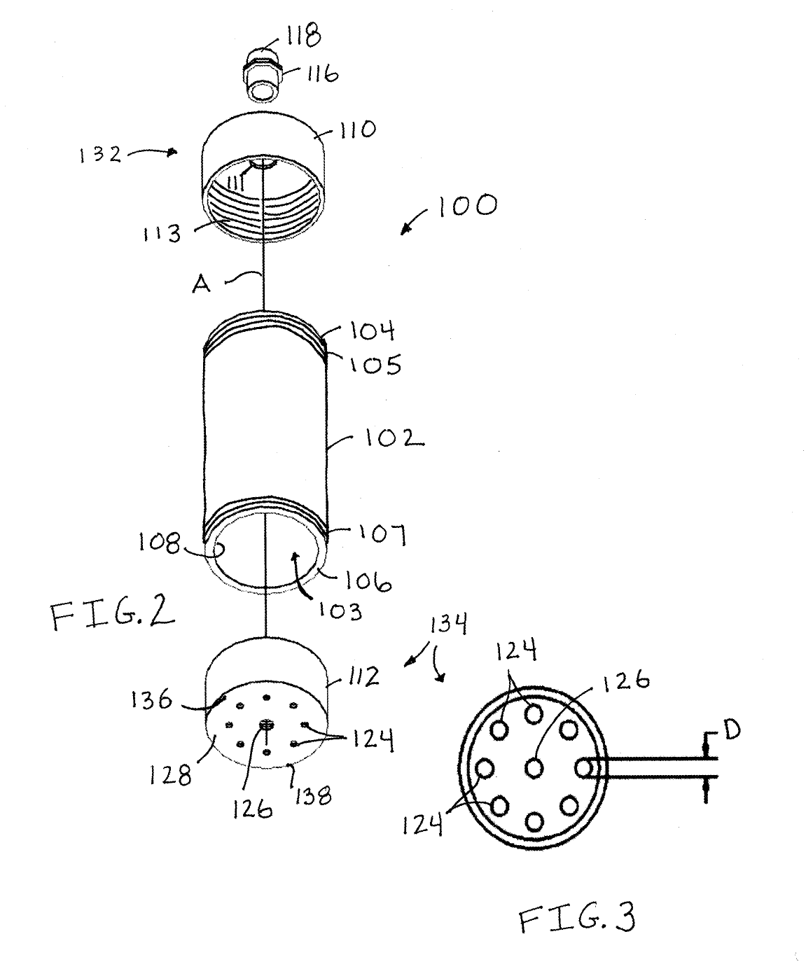

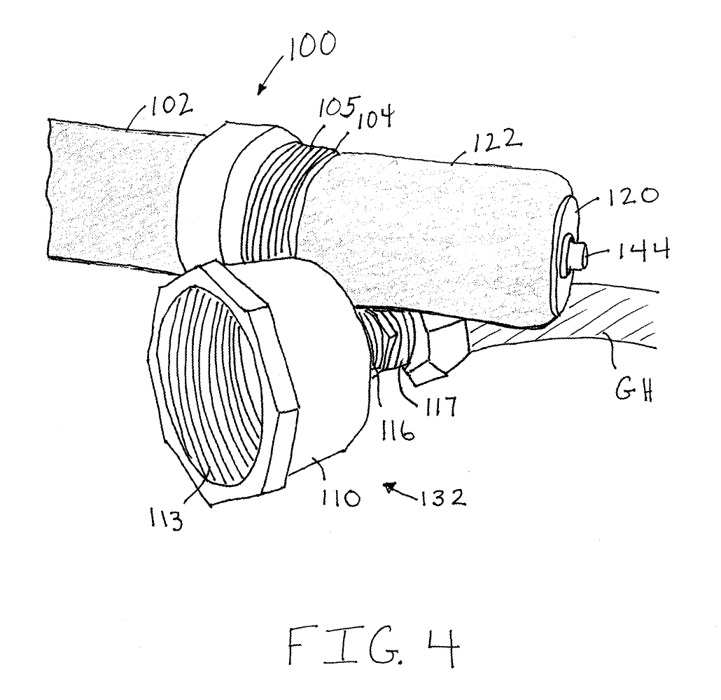

The second end 134, which may include the discharge cap 112, is essential to the operation of the roller applicator cleaning device 100. The second end 134, as best seen in FIGS. 2-3, includes a plurality of equi-distance, concentrically-arranged holes 124 therethrough that are in fluid communication with the chamber 101. The concentric arrangement of the holes 124 may be about a centerpoint of the end face 128. The centerpoint may be an alignment hole 126 for receiving an alignment member attached to the roller applicator. If the alignment hole 126 is present, it is not intended for fluid flow, but merely for alignment of the roller applicator within the device and is not included in the area defined by the holes 124. The holes 124 are sized and shaped to create back pressure within the tubular housing 102, i.e., the total discharge flow through the holes 124 is less than the inflow of fluid from the fluid source into the tubular housing 102, and turbulent fluid flow. In the embodiment illustrated in FIGS. 2 and 3, eight holes are present in the concentric arrangement, but more or less than eight holes are possible as long as backpressure is created to cause agitation of the water to more quickly clean the nap of the roller applicator. In another embodiment, four, five, six, or seven holes 124 may be present.

In one embodiment, the holes 124 are more proximate an outer edge 138 of the end face 128 of the discharge cap 112 than the center thereof. In another embodiment, the holes 124 may be equi-distant from the center and the outer edge 138 of the end face 128. The holes are dimensioned to have a diameter of about ⅛ inch to about 6/8 inches. In one embodiment, the diameter of each hole 124 is about 2/8 to about 4/8 inch, more preferably about 2/8 inch. While the holes 124 are depicted as all being the same size, in another embodiment, there may be a plurality of holes of one size and a plurality of holes of a second size that are not the same size.

The plurality of holes collectively defines a second area A_{H}. The ratio of the first area A_{EF} to the second area A_{H} is about 2:1 to 18:1. In another embodiment, the ratio of the first area A_{EF} to the second area A_{H} is about 3.5:1 to 18:1, and in a more preferred embodiment, the ratio of the first area A_{EF} to the second area A_{H} is about 8:1 to 18:1. In any one of these embodiments, the plurality of holes is four to ten holes that each have a diameter in the range of ⅛ inch to 6/8 inch. Moreover, each of the plurality of holes is spaced equally distant from adjacent neighboring holes. When the ratio of the first area A_{EF} to the second area A_{H} is about 3.5:1 to 18:1 or about 8:1 to about 18:1, the plurality of holes can be six to eight holes each having a diameter in the range of 2/8 inch to 4/8 inch.

The roller applicator cleaning apparatus 100 of FIG. 1 also include are two end plugs or caps 120 that fit within the ends of the roller applicator. FIG. 4 illustrates one end plug 120 inserted into the roller applicator. Each cap 120 includes an insert portion 140 shaped and sized to fit within an end of the roller applicator extending from a closed portion 142 of the cap, and a post or peg 144 protruding from the closed portion in a direction opposite from the insert portion 140. The post or peg 144 may be received within a mating receptacle or hole (e.g., hole 126 in the discharge cap 112 of FIG. 2) in the first end 132 or the fluid inlet cap 110 or the second end 134 or the discharge cap 112 of the roller applicator cleaning apparatus 110. The opposite configuration is also possible, i.e., the cap having a post or peg and the end plugs 120 having a receptacle therefor. The post or peg 144 provides and maintains alignment of the roller applicator within the tubular housing 102, in particular during the cleansing process.

Rather than having loose end plugs 120, which may be misplaced by the user, the roller applicator cleaning apparatus 100 may have one or both end plugs integrally formed in the first end 132 and/or the second end 134. If the first end 132 includes the inlet cap 110, a first end plug may be an integral part of the interior of the inlet cap 110. Similarly, if the second end 134 includes a discharge cap 112, a second end plug may be an integral part of the interior of the discharge cap 112.

The use of the roller applicator cleaning device 100 will be demonstrated by reference to a paint roller. A used paint roller is removed from its handle assembly, and the caps 120 are placed in opposing ends of the paint roller. The paint roller is then inserted into either open end 104, 106 of the housing 102 (as shown in FIG. 4), whichever one may be present. Thereafter, the discharge cap 112 and the fluid inlet cap 110, whichever one if present or both, are secured to the tubular housing 102. One of the two caps 110, 112 may have already been attached to the tubular housing 102 at the time the paint roller was inserted or may have been permanently affixed thereto.

The connector 116 of the fluid inlet cap or the connector 116′ of the valve 114, if present, is connected to a cleaning fluid such as water from a faucet or a hose, and fluid under pressure is admitted into the housing 102. The fluid flows toward the inserted capped paint roller, the end cap 120 diverts the water flow uniformly around the exterior of the paint roller with fluid flow being generally axial within the chamber 101 of the housing 102. The water flows axially in the housing 102 between the paint roller core and the inner surface of the housing, and thus is directed through the roller nap. The pressurized fluid flow reaches the discharge cap 112, which because of the orientation and size of the holes 124, creates backpressure of the fluid flow agitating and quickly cleaning the paint from the roller nap.

The fluid containing the paint or other coating material is controllably discharged and the paint roller is left clean and ready for reuse or for drying and storage. The roller is removed from the housing by removing either the fluid inlet cap 110 or the discharge cap 112 and sliding the roller from the housing. The caps 120 are thereafter removed from the ends of the roller, and the cleaning apparatus is available to be used again.

In an embodiment having integral end plugs, the process is generally the same, except that the paint roller is inserted into either of the first end 132 or the second end 134, or the inlet cap 110 or the discharge cap 112, if present, with an end thereof received over the respective end plug, and, thereafter, the opposite end or cap is introduced over the other end of the paint roller with the other end plug inserted into the paint roller.

Important advantages of the paint roller apparatus are: use of significantly less water to clean the roller applicator in a shorter period of time, and collection of the fluid used for the cleaning for disposal in a more environmentally friendly manner. The roller applicator cleaning apparatus cleans a paint roller saturated with paint in less than two minutes starting at the introduction of cleaning fluid, such as water, into the apparatus. In one trial, the roller applicator cleaning apparatus cleaned a paint roller saturated with paint in less than 100 seconds or even less than 65 seconds.

The apparatus may provide a quick disconnect mechanism instead of the threaded end connection to achieve even greater economy of time and effort. The housing and associated structures may be formed of plastic or polymer material, such as, but not limited to, PVC, ABS, Polyethylene, or the like.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

What is claimed is:

1. A roller applicator cleaning device comprising:
a generally cylindrical casing defining a chamber sized to receive a roller applicator, having a longitudinal axis, having a first end defining an inlet to receive fluid, and having a second end comprising an end face defining a first area and being oriented transverse to the longitudinal axis, thereby providing generally axial fluid flow from the first end to the second end through the chamber;
a first end plug insertable into one end of the roller applicator, the first end plug being integral with the first end or receivable in the first end; and
a second end plug insertable into the other end of the roller applicator, the second end plug being integral with the second end or receivable in the second end;
wherein the end face comprises a plurality of holes therethrough in fluid communication with the chamber, the plurality of holes collectively defining a second area;
wherein a ratio of the first area to the second area is about 2:1 to 18:1.

2. The roller applicator cleaning device of claim 1, wherein the ratio of the first area to the second area is about 3.5:1 to 18:1.

3. The roller applicator cleaning device of claim 1, wherein the ratio of the first area to the second area is about 8:1 to 18:1.

4. The roller applicator cleaning device of claim 1, wherein the plurality of holes comprises four to ten holes that each have a diameter in the range of ⅛ inch to 6/8 inch.

5. The roller applicator cleaning device of claim 4, wherein the plurality of holes is spaced equally distant from adjacent neighboring holes and generally concentrically arranged around a centerpoint of the end face.

6. The roller applicator cleaning device of claim 1, wherein the plurality of holes comprises six to eight holes each having a diameter in the range of 2/8 inch to 4/8 inch.

7. The roller applicator cleaning device of claim 6, wherein the plurality of holes is spaced equally distant from adjacent neighboring holes and generally concentrically arranged around a centerpoint of the end face.

8. The roller applicator cleaning device of claim 1, wherein at least one of the first end or the second end of the generally cylindrical casing is a releaseably attachable cap closing an open end thereof, wherein the roller applicator is insertable into the generally cylindrical casing through the open end.

9. The roller applicator cleaning device of claim 8, wherein the generally cylindrical casing has a primary portion having a length that is about ½ inch to 2 inches shorter than the length of the roller applicator and the cap defines a remainder length necessary to encapsulate the roller applicator.

10. The roller applicator cleaning device of claim 8, wherein both the first end and the second end of the generally cylindrical casing are releasably attachable caps closing opposing open ends thereof.

11. The roller applicator cleaning device of claim 1, wherein the generally cylindrical casing includes a primary portion thereof made of a transparent material.

12. The roller applicator cleaning device of claim 1, wherein the first end of the generally cylindrical casing includes a valve for controlling the axial fluid flow into the chamber.

13. The roller applicator cleaning device of claim 12, wherein the valve includes a connector connectable to a fluid source.

14. The roller applicator cleaning device of claim 1, wherein the inlet at the first end of the generally cylindrical casing includes a connector connectable to a fluid source.
